(19) United States
(12) Patent Application Publication
(10) Pub. No.: US 2026/0280605 A1
(43) Pub. Date: Sep. 17, 2026

(54) Connection system, in particular plug-in connection system, for induc-tively contactlessly transmitting data and/or power supply signals and combination

(71) Applicant: Knick Elektronische Messgeräte GmbH & Co. KG, Berlin (DE)

(72) Inventor: Harald ZANK, Berlin (DE)

(73) Assignee: Knick Elektronische Messgeräte GmbH & Co. KG, Berlin (DE)

(21) Appl. No.: 19/165,124

(22) PCT Filed: Mar. 12, 2024
(86) PCT No.: PCT/EP2024/056562

§ 371 Date: Sep. 14, 2025

(30) Foreign Application Priority Data
Mar. 16, 2023 (DE) 10 2023 202 368.7

(51) Int. Cl. H04B 5/79; H02J 50/10; H04B 5/26

(52) U.S. Cl. CPC H04B 5/79; H02J 50/10; H04B 5/266

(57) ABSTRACT

A connection system (1), in particular plug-in connection system, for inductively contactlessly transmitting data and/or power supply signals between a sensor device and base unit in a measurement and transmission system, includes a sensor-side connection element (2) with a first coil winding (5), a base-side connection element (6) with a second coil winding (10). The base-side connection element (6) can be engaged with the sensor-side connection element (2) for magnetic coupling for data and/or energy transmission. A short-circuit winding element made of an electrically conductive material surrounds the engagement area (E) between the sensor-side connection element (2) and the base-side connection element (6). A combination (17) includes the connection system (1) and a support unit (18), in particular an immersion fitting, which can be engaged with the connection system (1). A measurement combination includes the connection system (1) or the combination (17) and the sensor device.

### CROSS-REFERENCE TO RELATED APPLICATION

This application is a national stage application, filed under 35 U.S.C. § 371, of International Patent Application PCT/EP2024/056562, filed on Mar. 12, 2024. The present patent application claims the priority of the German patent application DE 10 2023 202 368.7, filed Mar. 16, 2023, the contents of which are incorporated herein by reference.

### TECHNICAL FIELD

The disclosure relates to a connection system, in particular plug-in connection system, for inductively contactlessly transmitting data and/or power supply signals. The disclosure further relates to a combination having such a connection system.

### BACKGROUND

DE 197 19 730 C1 relates to a plug-in connection system for contactlessly transmitting data and power supply signals between a sensor device and a base unit in a measurement and transmission system. A sensor device, for example for a temperature sensor, is coupled to a sensor-side plug-in connection element. The sensor device has a certain level of “intelligence” as it has an AD converter for the measurement signal of the thermocouple representing the measurement sensor and a microprocessor-based control and storage device connected downstream thereof. A data modulator-demodulator unit in combination with a power receiver is provided in the sensor-side plug-in connection element, which is coupled to the sensor device, and is connected to a first coupling partner element of an inductive coupling for contactlessly transmitting data and power supply signals. The second coupling partner element of the inductive coupling path is located in the base-side plug-in connection element, which is connected to the corresponding lines of a bus system in terms of data and power supply. In this base-side plug-in connection element, a data modulator-demodulator unit combined with an energy transmitter is provided, which supplies power to the sensor system via the primary power supply from the bus system.

Known systems of this type available on the market are, for example, the Memosens® system (by Endress+Hauser) and the Inducon® system (Knick). Such a plug-in system usually consists of two assemblies-a so-called sensor assembly as the sensor-side connection element and a so-called cable assembly as the base-side connection element. The values measured in the sensor assembly (such as pH value) are inductively transmitted to the attached cable assembly and then digitally transmitted to a so-called transmitter, for example via an RS485 interface. The transmitter, in turn, can visualise and store this data and transmit it via another interface to a higher-level installation control system or remote control station. The inductive system of the aforementioned systems is designed such that both auxiliary power and data (usually in a semi duplex mode) are transmitted via the same magnetic components. The inductive component on the cable assembly side usually consists of a thin ferrite rod with an associated coil winding. The inductive component on the cable assembly side usually consists of a coil with a larger diameter without ferrite/magnetic material. The aforementioned assemblies and inductive components are usually respectively encapsulated and potted. The housing is designed in such a way that a lockable mechanical plug-in connection is formed. The coil on the cable assembly side slides into the sensor coil with a relevant portion, thereby forming a corresponding engagement area through this engagement. This results in magnetic coupling which enables the functionality described above. The housing components and potting materials are usually electrically non-conductive and magnetically inactive.

The aforementioned connection systems are used in nearly all applications in the chemical industry, research, etc. Two extreme cases can be identified here. On the one hand, the connection system can be operated in an environment in which there are no electrically conductive materials or materials influencing the magnetic circuit in the immediate vicinity of the inductive system. This operating condition occurs, for example, when the system is held manually in a medium.

On the other hand, the sensor can be operated in a so-called fitting (possibly immersion fitting), which is designed such that the connection system and thus also the inductive system located in it is completely surrounded by an electrically conductive material (for example often by a stainless-steel pipe). This complete enclosure constitutes, inter alia, a short-circuit winding for the inductive system and has a considerable effect on the electrical properties of the inductive system of the connected arrangement. As a result, inter alia, the coupling factor and loss factor of the inductive system change. Although it is possible, in principle, to adjust and optimise the entire system to the new properties of the inductive system resulting from this short-circuit winding, considerable limitations in operating conditions are to be expected without such influence. Optimisation in this context thus invariably involves a trade-off between these two conditions. The manufacturer of such a system must invest considerable effort in development and testing in practice in order to guarantee the operational reliability of such a sensor system under all operating and installation conditions.

DE 10 2013 111 405 A1 should be mentioned as technological background, disclosing a magnetic shield for inductive plug-in connections in the form of a sleeve arranged around this inductive plug-in connection. In order to achieve an optimised magnetic shielding effect, the material of the sleeve is ferromagnetic with a permeability >1. In addition, the sleeve is interrupted with a longitudinal slot relative to the circumferential direction in order to prevent a short-circuit effect.

### SUMMARY

Based on the aforementioned issue with the prior art, an object of the disclosure is to improve such a connection system in such a way that the inductive signal transmission between sensor-side and base-side connection element works unaffected by induction-relevant environmental factors.

This object is achieved by the fact that a short-circuit winding element made of an electrically conductive material surrounds the engagement area between the sensor-side and base-side connection element.

With regard to the aforementioned issue, this short-circuit winding element has the effect that the influence of another (external) short-circuit winding or short-circuit-like winding (such as in the form of a fitting surrounding the connection system) on the inductive system of the sensor arrangement no longer results in any or at least no relevant further detuning of the system. The system is now permanently in a single state influenced by the short-circuit winding element and can thus be permanently optimised for this one operating case. It is also possible to reduce interference from adjacent sensors, such as sensors in a bundle. This simplifies the development process and, above all, the test procedures, which are intended to ensure safe operation of the connection system in all operating and installation scenarios.

The connection system is preferably designed to inductively contactlessly transmit at least data signals, in particular digital and/or analogue data signals, preferably further power supply signals, between the sensor device and the base unit.

The short-circuit winding element is understood as an electrical conductor which has at least one electrically short-circuited winding. In other words, the short-circuit winding element has a conductor which forms a closed circuit. The first and second coil windings preferably have a coil axis. The electrical conductor, in particular the circuit, preferably surrounds the engagement area and/or the sensor-side connection element and/or the base-side connection element, in particular their respective coil axis. An aspect ratio of the cross-section of the electrical conductor is preferably in the range of 1 to 1000, in particular 2 to 200, in particular 3 to 100, in particular 5 to 80, in particular 10 to 60, in particular 15 to 40, in particular 20 to 30.

The engagement area is preferably understood as the area in which the first and second coil windings are arranged when the sensor-side and base-side connection elements are in engagement. The engagement area extends in particular within a smallest convex hull, which surrounds the first and second coil winding in this arrangement. Preferably, in the engagement arrangement, the first or second coil winding surrounds the other coil winding.

According to one aspect, the sensor-side and base-side connection elements can be engaged by plugging together. The plug-in engagement can have means for forming a frictional and/or form-fit connection, in particular a latching connection and/or a bayonet connection.

The short-circuit winding element can be designed a short-circuit winding body, in particular integrally with or separately from a housing of the sensor-side or base-side connection element. Alternatively, the short-circuit winding element can be designed as a coating, in particular of a housing of the sensor-side or base-side connection element.

Preferred embodiments of the connection system are laid out in the dependent claims. The embodiment of the short-circuit winding element as a short-circuit sleeve is advantageously simple. The short-circuit sleeve preferably surrounds the engagement area in such a way that it overlaps the engagement area at least in sections, in particular fully, in an orthogonal projection onto a plane oriented parallel to the coil axis. The short-circuit sleeve is preferably designed to be electrically conductive all the way around, in particular the engagement zone and/or the coil axis.

The electrical resistance, in particular the ohmic resistance, of the circuit formed by the short-circuit wining element is preferably no more than 1 kΩ, in particular no more than 1 Ω, in particular no more than 1 mΩ, in particular no more than 100 μΩ, in particular no more than 1 uΩ, and/or at least 1 nΩ. The electrical resistance and/or a resistivity and/or a conductor cross-section of the short-circuit winding element can be constant or variable over the conductor length of the short-circuit winding element, in particular with a difference between a maximum value and a minimum value of at least 25% of the maximum value. The resistivity of the material of the short-circuit winding element is preferably no more than 1 kΩmm²/m, in particular no more than 10 Ωmm²/m, in particular no more than 1 Ωmm²/m, in particular no more than 0.1 Ωmm²/m, and/or at least 0.01 Ωmm²/m, in particular at least 0.1 Ωmm²/m.

The axial length of the short-circuit sleeve preferably overlaps the engagement area at least in sections, in particular over at least 10%, in particular over at least 20%, in particular over at least 50%, in particular over at least 75%, in particular over at least 100%, of the length of the engagement area, in particular along the coil axis. The axial length is understood as the length along the coil axis. This constitutes, on the one hand, a mechanically simple yet robust design of the short-circuit winding element, and on the other hand, an effective neutralisation of the influence of external circumferential short-circuit elements.

According to one aspect, the short-circuit winding element, in particular the short-circuit sleeve, is not electrically contacted. This is understood to mean that the short-circuit winding element does not have an electrically conductive connection to another object. The short-circuit winding element can be arranged electrically insulated from the sensor-side and/or base-side connection element. It is advantageous in particular if the short-circuit winding element is electrically insulated from a shield and/or from a data and/or power supply signal connection, in particular from every electrical line, of the sensor-side and/or base-side connection element. This prevents electrically transmitted interference effects from affecting the short-circuit winding element and thus the sensitive coupling area at the engagement area.

According to one aspect, the short-circuit winding element, in particular the short-circuit sleeve, extends over a length in a range of 10% to 1,000%, in particular 50% to 500%, in particular 100% to 250%, of the overall length of the engagement area and/or in a range of 0.1 mm to 100 mm, in particular 0.5 mm to 75 mm, in particular 1 mm to 50 mm, in particular 2 mm to 40 mm, in particular 5 mm to 20 mm, in particular axially to the short-circuit sleeve and/or along the signal line and/or along the coil axis.

According to another aspect, the short-circuit winding element can have a material with an electrical conductivity of at least 3×10⁷ S/m, in particular at least 4×10⁷ S/m, in particular at least 5×10⁷ S/m, in particular can consist thereof. As a result, the desired effect is particularly reliably achieved, namely the influence of another external short-circuit winding on the connection system does not result in any or at least no relevant detuning of the inductive coupling path.

The connection system is preferably designed to transmit data signals between the sensor-side and base-side connection element. For this purpose, the signal transmitted between the connection elements can be modulated. In particular, a modulator unit, in particular a modulator-demodulator unit, can in particular respectively be connected to the first and/or second coil winding. A correspondingly modulated signal is susceptible to external influences. The short-circuit winding element reduces the susceptibility to interference and ensures the reliable transmission of the modulated signal, in particular the modulated data signal.

According to another aspect, there is no electrically conductive connection, in particular no galvanic connection, between the sensor-side connection element and the base-side connection element. As a result, the connection system is suitable for use in a potentially explosive environment. Interfering influences on the inductive coupling path and/or interfering influences on the sensor device and/or base unit connected thereto due to the conductive connection across the connection system can also be avoided.

Non-magnetic materials are understood as non-ferromagnetic materials, preferably diamagnetic and/or paramagnetic materials. The preferred non-magnetic metals are in particular aluminium, copper or stainless steel or corresponding non-magnetic metal alloys. These ensure effective protection without causing an undesired magnetic shielding effect. The short-circuit winding element preferably has a magnetic permeability in a range of no more than 1×10³, in particular no more than 1×10², in particular no more than 1×10¹, in particular no more than 1, in particular no more than 1×10⁻¹, in particular no more than 1×10⁻³, in particular no more than 1×10⁻⁵. This ensures that the technical effect emanating from the short-circuit winding element is reliably achieved, namely to produce a magnetic reaction on the first and/or second coil winding, in particular due to a short-circuit current induced in the short-circuit winding element caused by the current-carrying first and/or second coil winding.

The same objective is achieved by the advantageous embodiment of a short-circuit sleeve as a continuous, uninterrupted ring, in particular with regard to electrical conductivity, in particular a sleeve body.

Other preferred embodiments relate to the mechanical fixation of the short-circuit sleeve on the housing of the sensor-side or base-side connection element, for example via a form-fitting engagement of the short-circuit winding element, in particular of the short-circuit sleeve, with the housing. The form-fitting engagement formed between the short-circuit winding element, in particular the short-circuit sleeve, and the housing preferably creates a form fit in the direction of the coil axis and/or in the circumferential direction around the coil axis and/or radially to the coil axis.

The form-fitting engagement can be formed by an outside groove in the housing of the connection element and a latching projection on the inside of the short-circuit sleeve engaging therein. The latching projection in turn can be produced by an embossed recess in the short-circuit sleeve made from the outside with simple production techniques.

The short-circuit winding element can also consist of an electrically conductive or electrically conductive-coated plastic so that injection moulding production processes are available for its manufacture. The short-circuit winding element can also be produced using deep-drawing, injection moulding, sintering or 3D printing.

A short-circuit winding element formed as a separate component can be avoided with the effect of corresponding production streamlining if the housing material of the sensor-side or base-side connection element is itself manufactured from an electrically conductive or electrically conductive-coated plastic material.

A connection system with a circumferential short-circuit winding element can not only be produced for newly designed connection systems, but can also be retrofitted to existing systems. For this purpose, the short-circuit winding element can, for example, be connected to the housing of the sensor-side or base-side connection element using a force-fit and/or material-bonded connection, in particular by means of bonding.

The short-circuit winding element is preferably permanently connected to the sensor-side and/or base-side connection element, in particular cannot be released without damage. The connection can be designed as a material bond, in particular adhesive bonding, and/or as a form-fitting connection, in particular a latching connection.

An axial extension of the short-circuit winding element, in particular the short-circuit sleeve, along the coil axis is preferably no more than ten times, in particular no more than four times, in particular no more than three times, in particular no more than twice, in particular no more than 1.5 times, in particular no more than once, in particular no more than 0.7 times, in particular no more than 0.5 times, as large and/or at least 0.1 times, in particular at least 0.5 times, in particular at least once, as large as the axial extension of the engagement area and/or the first and/or second coil winding, along the coil axis. The advantage of this is that the connection system can be designed to be particularly compact and the magnetic coupling is reliable in operation.

Another object of the disclosure is to provide an improved combination, which in particular ensures the inductive signal transmission between sensor-side and base-side connection element unaffected by induction-relevant environmental factors.

This object is achieved by a combination having a connection system as disclosed and a support unit, in particular an immersion fitting, which can be engaged with the connection system. The advantages of the combination correspond to the advantages of the connection system described above. The combination is preferably further developed with at least one of the features described above in connection with the connection system.

The support unit is designed to support the connection system, in particular as a fitting, in particular an immersion fitting, and/or as a measuring probe. The support unit is preferably tubular, in particular in the region of the engagement section. The connection system can be reversibly arranged in an interior of the support unit, which is tubular at least in sections. The connection system can preferably be attached to the support unit, in particular can be reversibly locked in place.

The support unit can have an electrically conductive material, in particular an iron-based alloy, in particular stainless steel, in particular consist thereof, in particular in the engagement section.

According to another aspect, an electrically conductive part of the support unit surrounds the engagement area. A smallest convex hull of an electrically conductive part of the support unit preferably fully encloses the engagement area, in particular the first and/or second coil winding, in particular when the sensor-side and base-side connection elements are in engagement.

Another object of the disclosure is to provide an improved measurement combination, which in particular ensures the inductive data and/or power supply signal transmission between sensor-side and base-side connection element unaffected by induction-relevant environmental factors.

This object is achieved by a measurement combination having a connection system as described, or a combination as described, and the sensor device, which is connected to the sensor-side connection element for data signal transmission. The advantages of the measurement combination correspond to the advantages of the connection system described above and the combination described above. The measurement combination is preferably further developed with at least one of the features described above in connection with the connection system and/or combination.

The sensor device preferably has at least one measurement sensor. The measurement sensor can, for example, be a pH measurement sensor.

The sensor device, in particular the at least one measurement sensor, is preferably designed to provide digital and/or analogue data signals. Corresponding data signals can preferably be transmitted via the connection system. In addition, the connection system can be designed to transmit energy signals, in particular to supply the sensor device, in particular the at least one measurement sensor, with the electrical power required for its operation.

Further features, details and advantages of the invention result from the following description of an exemplary embodiment based on the appended drawings.

### BRIEF DESCRIPTION OF THE DRAWINGS

FIG. 1 shows a perspective, partially broken away view of a connection system with separate connection elements.

FIG. 2 shows a schematic side view of a base-side connection element with a short-circuit sleeve in an intermediate manufacturing step.

FIG. 3 shows a cross-section of the short-circuit sleeve along the section line III-III according to FIG. 2.

FIG. 4 shows a schematic side view of a combination with the connection system in FIG. 1 and a support unit for supporting the connection system.

### DETAILED DESCRIPTION

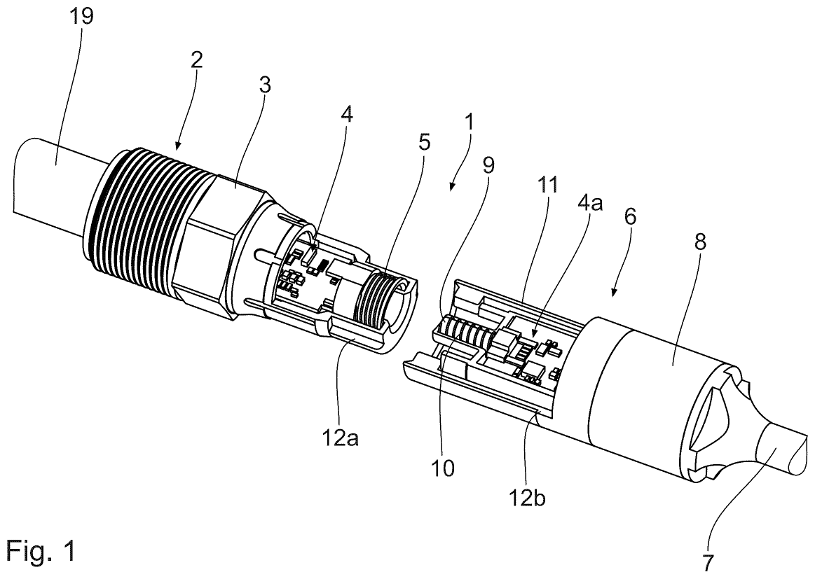

The plug-in connection system 1 shown in FIG. 1 is used to inductively contactlessly transmit data and power supply signals between a base unit and a sensor device, such as a pH measurement sensor. The sensor device has a measurement head, in particular a measurement electrode 19. The measurement head is rigidly connected to the sensor-side connection element 2, in particular cannot be released without damage.

The plug-in connection system 1, in particular the sensor-side connection element 2, has a connection means, in particular for producing a screw connection, for the in particular media-tight connection of the plug-in connection system 1 to a wall of a measurement chamber. As intended, the plug-in connection system 1 is arranged outside the measurement chamber and the sensor head is arranged within the measurement chamber.

According to an alternative embodiment (not shown), the sensor head can be connected to the sensor-side connection element 2 by means of a cable connection.

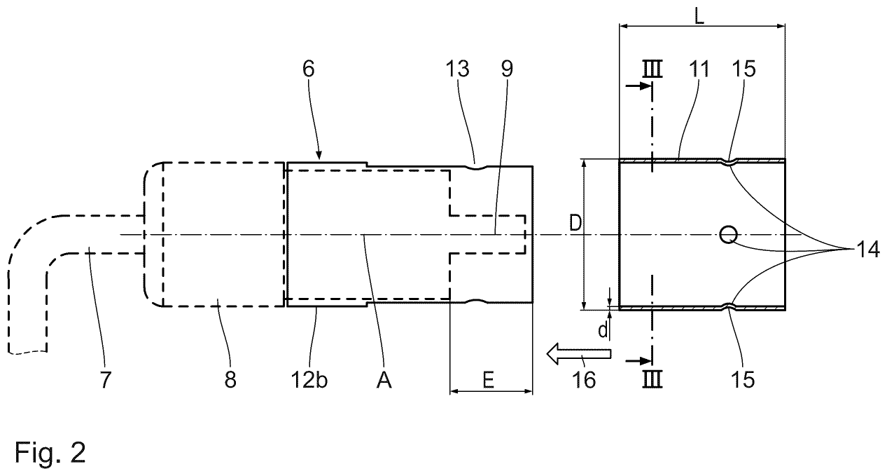

The latter has a standard housing 3, which houses a standard measurement signal processing circuit 4 with a microprocessor-based control and storage unit and a data modulator-demodulator unit in combination with a power receiver and is connected to a first coupling partner element of an inductive coupling for contactlessly transmitting of data and power supply signals. This first coupling partner element is a sensor-side coil winding 5, which cooperates with the second coupling partner element of the inductive coupling path in the base-side plug-in connection element 6. This is in turn housed in a housing 8 and connected to the corresponding lines of a bus system via a cable 7 in terms of data and power supply. The base-side inductive component usually consists of a thin ferrite rod 9 with an associated coil winding 10. In this base-side plug-in connection element 6, a processing circuit 4a, which combines a data modulator-demodulator unit with an energy transmitter, is provided, and supplies power to the sensor system via the primary power supply from the bus system. In the connected position of the connection elements 2, 6 (not shown in the figures), the coil winding 5 and the ferrite rod 9 with the coil winding 10 engage with one another and thus mark engagement area E (see FIG. 2). The congruently designed housings 3, 8 of the connection elements 2, 6 lock via a form-fitting connection 12 and thus establish a mechanically secure connection between the sensor-side and base-side plug-in connection elements 2, 6. The form-fitting connection 12 comprises a sensor-side engagement part 12a and a base-side base part 12b. The sensor-side engagement part 12a is designed as the plug. The base-side engagement part 12b is designed as the socket. In particular, the base-side engagement part 12b is rotatably mounted relative to the housing 8, in particular about a central longitudinal axis of the base-side connecting element 6. The form-fitting connection 12 is designed as a bayonet connection.

The sensor-side housing 3 and/or the base-side housing 8 preferably comprise an electrically non-conductive material, in particular a plastic material, preferably produced in a plastic injection moulding process, in particular they consist thereof. The same preferably applies to the base-side engagement part 12b. The housing 3, 8 and the base-side engagement part 12b preferably consist of a non-ferromagnetic material, in particular of a paramagnetic or diamagnetic material.

As shown in FIGS. 1 and 2, a short-circuit sleeve 11 sits on the housing 8 of the base-side plug-in connection element 6 as a short-circuit winding element and is arranged around the engagement area E and surrounds the housing 8 of the base-side connection element 6 without interruption. This short-circuit sleeve 11 consists, for example, of copper as an electrically conductive, but non-magnetic metal. An axial extension L of the short-circuit sleeve 11 along a coil axis A is, for example, twice as large as an axial extension 1 of the engagement area E along the coil axis A. Its wall thickness d is, for example, 0.5 mm, it outer diameter D is, for example, 19 mm and its length L along the coil axis A is, for example 16 mm. The axial extension 1 of the engagement area E along the coil axis A is, for example, 8 mm.

According to one advantageous alternative, the short-circuit sleeve 11 can be formed by the base-side engagement part 12b. For this purpose, the base-side engagement part 12b could have an electrically conductive material, in particular a metallic material, in particular it could consist thereof.

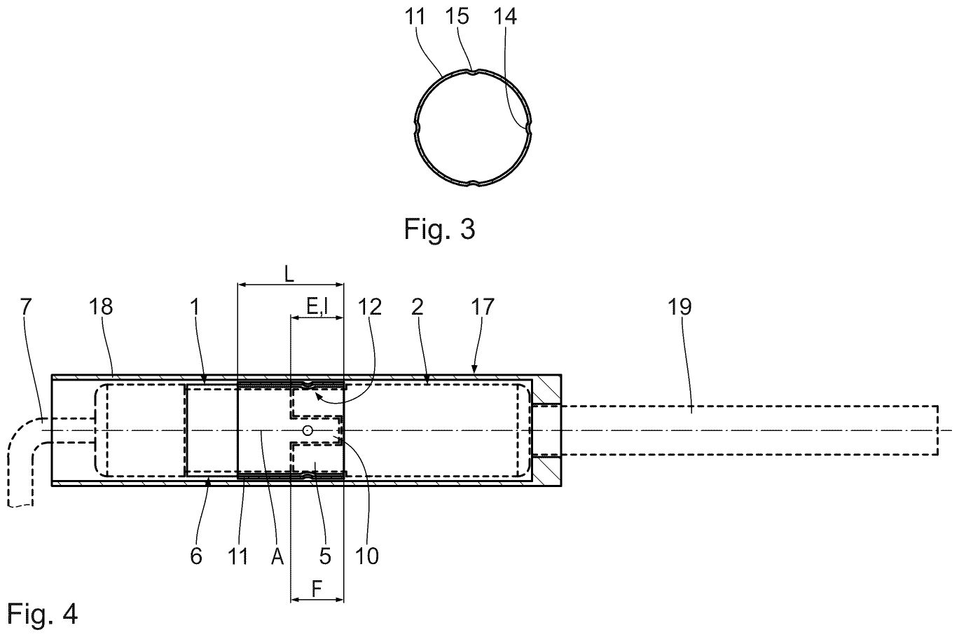

As shown in FIGS. 2 and 3, in order to fix the short-circuit sleeve 11 on the base-side connection element 6, in particular on the base-side engagement part 12b, a form-fitting engagement is provided, which consists of at least one, preferably at least two, in particular at least three, in particular exactly four latching recesses 13 arranged on the outside of the housing 8, in particular spaced at regular angular intervals around the circumference of the housing 8, in particular respectively in the form of a dome-shaped recess and/or a cavity and/or an in particular circumferential groove on the one hand, and on the other hand, at least one complementary latching projection 14 on the inside of the short-circuit sleeve 11. The number and/or arrangement of the at least one latching projection 14 preferably correspond to those of the at least one latching recess 13. The form-fitting engagement preferably forms an axially fixed and/or rotationally fixed, in particular a completely fixed, connection between the housing 8 and the short-circuit sleeve 11. The latching projections 14 are preferably formed by embossed recesses 15 made from the outside using standard embossing dies. Embossing can take place before or after sliding (arrow 16) the short-circuit sleeve 11 onto the housing 8. The short-circuit sleeve 11 can be releasably connected to the housing 8, in particular can be released without damage. The short-circuit sleeve 11 is preferably permanently connected to the housing 8, in particular cannot be released without damage.

FIG. 4 shows a combination 17, having the connection system 1 and a support unit 18 designed to support the connection system 1. The support unit 18 is designed as a so-called measuring probe or fitting, in particular immersion fitting. The connection system 1 can engage with the support unit 18. In particular, the connection system 1 can be reversibly arranged, in particular attached, in an interior of the tubular support unit 18.

The support unit 18 consists of an electrically conductive material, in particular of an iron-based alloy, in particular of stainless steel. In an engagement section F, the support unit 18 overlaps the engagement area E, in particular in an orthogonal projection onto a plane oriented parallel to the coil axis A. In the engagement section F, the electrically conductive support unit 18 completely surrounds the engagement area E, in particular in the form of a closed circuit surrounding the coil axis A, in particular in the form of a short-circuit winding. Thanks to the arrangement of the short-circuit sleeve 11 at the engagement area E, the inductive transmission behaviour between the sensor-side and base-side connection elements 2, 6 is largely independent of the presence of the support unit 18 or other objects exerting a feedback effect on the inductive transmission behaviour, in particular in the vicinity of the connection system 1. The advantage of this is that the connection system 1 can be operated equally reliably with the support unit 18, i.e. in the combination, or without the support unit 18.

1.-18. (canceled)

19. A plug-in connection system for inductively contactlessly transmitting data and/or power between a sensor device and a base unit in a measurement and transmission system, comprising:
a sensor-side connection element (2) with a first coil winding (5);
a base-side connection element (6) with a second coil winding (10); and
a short-circuit winding element made of an electrically conductive material which surrounds an engagement area (E) between the sensor-side connection element (2) and the base-side connection element (6),
wherein the base-side connection element (6) can be engaged with the sensor-side connection element (2) for magnetic coupling for data and/or energy transmission,
wherein there is no electrically conductive connection between the sensor-side connection element (2) and the base-side connection element (6), and
wherein the short-circuit winding element is not electrically contacted.

20. The plug-in connection system according to claim 19, wherein the short-circuit winding element is a short-circuit sleeve (11).

21. The plug-in connection system according to claim 20,
wherein an axial length (L) of the short-circuit sleeve (11) extends over an entire length of the engagement area (E).

22. The plug-in connection system according to claim 19,
wherein a modulator-demodulator unit is connected to the first coil winding (5) and/or the second coil winding (10) for transmitting data signals between the sensor-side connection element (2) and the base-side connection element (6).

23. The plug-in connection system according to claim 19,
wherein the short-circuit winding element has a material with an electrical conductivity of at least 3×10⁷ S/m.

24. The plug-in connection system according to claim 19,
wherein the short-circuit winding element consists of aluminium, copper, stainless steel, or a non-magnetic metal alloy.

25. The plug-in connection system according to claim 19,
wherein the short-circuit winding element is a continuous, uninterrupted ring.

26. The plug-in connection system according to claim 20,
wherein the short-circuit winding element is mechanically fixedly connected to a housing (3, 8) of the sensor-side connection element (2) or the base-side connection element (6) via a form-fitting engagement.

27. The plug-in connection system according to claim 26,
wherein the form-fitting engagement is formed by an outside latching recess (13) in the housing (3, 8) of the sensor-side connection element (2) or the base-side connection element (6) and a latching projection (14) engaging therein on an inside of the short-circuit winding element.

28. The plug-in connection system according to claim 27,
wherein the latching projection (14) is formed by an embossed recess (15) in the short-circuit sleeve (11) made from an outside.

29. The plug-in connection system according to claim 19,
wherein the short-circuit winding element is formed from an electrically conductive or electrically conductive-coated plastic material.

30. The plug-in connection system according to claim 19,
wherein the short-circuit winding element is formed from an electrically conductive or electrically conductive-coated housing material of the sensor-side connection element (2) or the base-side connection element (2).

31. The plug-in connection system according to claim 19,
wherein the short-circuit winding element is permanently connected to the sensor-side connection element (2) and/or the base-side connection element (6).

32. The plug-in connection system according to claim 19,
wherein an axial extension (L) of the short-circuit winding element along a coil axis (A) is no more than four times greater than the axial extension (1) of the engagement area (E) along the coil axis (A).

33. An assembly (17), comprising:
the plug-in connection system (1) according to claim 19, and
an immersion fitting (18), which can be engaged with the plug-in connection system (1).

34. The assembly (17) according to claim 33,
wherein the immersion fitting (18) has an engagement section (F) made of an electrically conductive material surrounding the engagement area (E).

35. The assembly (17) according to claim 34,
wherein the engagement section (F) comprises an iron-based alloy.

36. A measurement combination, having
the plug-in connection system (1) according to claim 19, and
the sensor device, which is connected to the sensor-side connection element (2) for data signal transmission.

37. A measurement combination, having
the assembly (17) according to claim 33, and
the sensor device, which is connected to the sensor-side connection element (2) for data signal transmission.
